(19) United States
(12) Patent Application Publication
(10) Pub. No.: US 2019/0248996 A1
(43) Pub. Date: Aug. 15, 2019

(54) INSULATION COMPOSITION AND ELECTRIC WIRE

(71) Applicant: Hitachi Metals, Ltd., Tokyo (JP)

(72) Inventor: Masanobu NAKAHASHI, Tokyo (JP)

(21) Appl. No.: 16/194,977

(22) Filed: Nov. 19, 2018

(30) Foreign Application Priority Data
Feb. 14, 2018 (JP) 2018-024349

(51) Int. Cl. C08L 27/18; C08L 23/14; H01B 3/44; H01B 7/295

(52) U.S. Cl. CPC C08L 27/18; C08L 23/147; H01B 3/445; C08L 2205/025; H01B 7/295; C08L 2201/02; C08L 2203/202; H01B 3/441

(57) ABSTRACT

An insulation composition includes 100 parts by mass of a resin component, 2 parts by mass or more and 20 parts by mass or less of zinc tin oxide, and 0.3 parts by mass or more and 15 parts by mass or less of a bromine flame retardant. A resin component includes a first component including a copolymer of tetrafluoroethylene and alfa-olefin with the carbon number of 2 or more and 4 or less, and a second component including ethylene-ethylacrylate copolymer. Mass proportion of the first component in the resin component is 70 percent by mass or more and 98 percent by mass or less. Mass proportion of the second component in the resin component is 2 percent by mass or more and 30 percent by mass or less.

### CROSS-REFERENCE TO RELATED APPLICATIONS

This application claims the benefit of Japanese Patent Application No. 2018-024349 filed on Feb. 14, 2018 with the Japan Patent Office, the disclosure of which is incorporated herein by reference.

### BACKGROUND

The present disclosure relates to an insulation composition and an electric wire.

A covering layer of an electric wire is required to have high thermostability and flame retardance. A known material for the covering layer is tetrafluoroethylene-propylene copolymer (see, Japanese Unexamined Patent Application Publication No. H2-0245047). Tetrafluoroethylene-propylene copolymer is an expensive material. Thus, a mixed material made of tetrafluoroethylene-propylene copolymer and less expensive materials such as polyolefin is sometimes used as a material for the covering layer.

### SUMMARY

However, such a mixed material, made of tetrafluoroethylene-propylene copolymer and a less expensive material such as polyolefin, generally has low flame retardance.

Thus, desirably, one aspect of the present disclosure provides an insulation composition and an electric wire that still have high flame retardance regardless of an extra component mixed with tetrafluoroethylene-propylene copolymer.

A first aspect of the present disclosure is an insulation composition. The insulation composition comprises 100 parts by mass of a resin component, 2 parts by mass or more and 20 parts by mass or less of zinc tin oxide, and 0.3 parts by mass or more and 15 parts by mass or less of a bromine flame retardant. The resin component comprises a first component including a copolymer of tetrafluoroethylene and alfa-olefin with the carbon number of 2 or more and 4 or less, and a second component including ethylene-ethylacrylate copolymer. Mass proportion of the first component in the resin component is 70 percent by mass or more and 98 percent by mass or less. Mass proportion of the second component in the resin component is 2 percent by mass or more and 30 percent by mass or less.

The insulation composition in the first aspect of the present disclosure has high flame retardance regardless of an extra component mixed with tetrafluoroethylene-propylene copolymer.

A second aspect of the present disclosure is an electric wire comprising a conductor, and a covering layer that covers the conductor. The covering layer includes the insulation composition in the first aspect of the present disclosure. The covering layer of the electric wire in the second aspect of the present disclosure has high flame retardance regardless of an extra component mixed with tetrafluoroethylene-propylene copolymer.

### BRIEF DESCRIPTION OF THE DRAWINGS

An example embodiment of the present disclosure will be described hereinafter with reference to the accompanying drawing, in which:

FIG. 1 is a sectional view showing a configuration of an electric wire 1.

### DETAILED DESCRIPTION OF THE PREFERRED EMBODIMENTS

An example embodiment of the present disclosure is explained hereinafter.

1. Insulation Composition

(1-1) Resin Component

An insulation composition of the present disclosure comprises a resin component. In the present disclosure, the resin component includes a resin and/or a rubber component. The resin component comprises a first component and a second component. The first component includes a copolymer of tetrafluoroethylene and alfa-olefin with the carbon number of 2 or more and 4 or less. The second component includes ethylene-ethylacrylate copolymer.

Alfa-olefin with the carbon number of 2 or more and 4 or less is, for example, propylene homopolymer and 1-butene homopolymer, and also a compound of two or more components selected from, for example, a group of ethylene, propylene, 1-butene, and isobutene. Preferably, alfa-olefin with the carbon number of 2 or more and 4 or less is propylene. If alfa-olefin with the carbon number of 2 or more and 4 or less is propylene, then the first component includes tetrafluoroethylene-propylene copolymer. If the first component includes tetrafluoroethylene-propylene copolymer, then the significance of effects of the insulation composition in the present disclosure increases further.

In the first component, a ratio of the number of moles of the tetrafluoroethylene to the number of moles of alfa-olefin with the carbon number of 2 or more and 4 or less (hereinafter referred to as the molar ratio of the main component) is preferably within a range from 95/5 to 30/70, and more preferably within a range from 90/10 to 45/55. If the molar ratio of the main component is within the range from 95/5 to 30/70, thermostability and moldability of the insulation composition of the present disclosure increase further.

Monomers included in the first component are mainly tetrafluoroethylene and alfa-olefin with the carbon number of 2 or more and 4 or less (hereinafter referred to as the main monomer). In addition to the main monomer, another monomer that is copolymerizable with the main monomer (hereinafter referred to as another monomer) may be included in the first component. The another monomer may be, for example, ethylene, isobutylene, acrylic acid, alkyl acrylate, vinyl fluoride, vinylidene fluoride, hexafluoropropylene, chloroethyl vinyl ether, chlorotrifluoroethylene, and perfluoroalkyl vinyl ether.

Preferably, the number-average molecular mass of the first component is 20,000 or more and 200,000 or less. If the number-average molecular mass of the first component is 20,000 or more and 200,000 or less, then extrudability and mechanical strength of the insulation composition increase further. If the number-average molecular mass of the first component is 200,000 or less, then the insulation composition of the present disclosure is less subject to cracking.

A method of controlling the number-average molecular mass of the first component may be, for example, a manipulation of the conditions for copolymerization reaction. The conditions for copolymerization reaction may be in terms of, for example, monomer concentration, concentration of polymerization initiator, ratio of an amount of monomer to an amount of polymerization initiator, polymerization temperature, and use of chain-transfer agent.

A method of controlling the number-average molecular mass of the first component may also be a reduction of molecular weight of copolymer by, for example, generating high molecular weight copolymer during copolymerization reaction followed by heating in the presence of oxygen.

In the resin component, the mass proportion of the first component is 70 percent by mass or more and 98 percent by mass or less, or more preferably, 90 percent by mass or more and 98 percent by mass or less. Also in the resin component, the mass proportion of the second component is 2 percent by mass or more and 30 percent by mass or less, or more preferably, 2 percent by mass or more and 10 percent by mass or less. Due to the mass proportion of the second component in the resin component being 30 percent by mass or less, the insulation composition in the present disclosure has high thermostability. In addition, due to the mass proportion of the second component in the resin component being 2 percent by mass or more, the cost of producing the insulation composition in the present disclosure is reduced.

Preferably, a melting point of the second component is 100° C. or less.

If the melting point of the second component is 100° C. or less, then the extrusion temperature to extrude the insulation composition in the present disclosure can be lowered.

(1-2) Zinc Tin Oxide

The insulation composition of the present disclosure includes 2 parts by mass or more and 20 parts by mass or less of zinc tin oxide with respect to 100 parts by mass of the resin component. Due to the content of the zinc tin oxide being 2 parts by mass or more, the flame retardance of the insulation composition of the present disclosure increases. Due to the content of the zinc tin oxide being 20 parts by mass or less, the thermostability of the insulation composition of the present disclosure increases. More preferably, the content of the zinc tin oxide with respect to 100 parts by mass of the resin component is 5 parts by mass or more and 10 parts by mass or less.

(1-3) Bromine Flame Retardant

The insulation composition of the present disclosure includes 0.3 parts by mass or more and 15 parts by mass or less of a bromine flame retardant with respect to 100 parts by mass of the resin component. Due to the content of the bromine flame retardant being 0.3 parts by mass or more, the flame retardance of the insulation composition of the present disclosure increases. Due to the content of the bromine flame retardant being 15 parts by mass or less, the thermostability of the insulation composition of the present disclosure increases. More preferably, the content of the bromine flame retardant with respect to 100 parts by mass of the resin component is 5 parts by mass or more and 10 parts by mass or less.

Preferably, the bromine flame retardant is ethylenebis (pentabromobenzene). If the bromine flame retardant includes ethylenebis (pentabromobenzene), then the safety and the flame retardance of the insulation composition of the present disclosure increase further.

(1-4) Other Components

The insulation composition of the present disclosure may also include, for example, a cross-linking agent, a cross-linking assisting agent, and a filler. The cross-linking agent and the cross-linking assisting agent are used for cross-linking. Cross-linking is, for example, chemical cross-linking and radiation cross-linking. The chemical cross-linking can be performed by using, for example, organic peroxide and amines. The radiation cross-linking can be performed by, for example, emitting ionizing radiation such as y-rays and electron rays.

Preferably, an organic peroxide cross-linking agent is used in the chemical cross-linking. The organic peroxide cross-linking agent can reduce residual ion impurities after cross-linking. Possible organic peroxide cross-linking agents are, for example, peroxyketal, hydroperoxide, dialkyl peroxide, diacyl peroxide, peroxy ester, and peroxy dicarbonate. One of the aforementioned organic peroxide cross-linking agents may be used alone, or two or more of these organic peroxide cross-linking agents may be mixed for use. Dialkyl peroxide is a particularly preferable organic peroxide cross-linking agent.

Preferably, the cross-linking assisting agent is allylic compound. Possible allylic compounds are, for example, triallyl isocyanurate, triallyl cyanurate, triallyltrimellitate, and tetraallyl pyromellitate.

Preferably, the filler is an inorganic filler. Possible inorganic fillers are, for example, silicic acid anhydride, magnesium silicate, aluminum silicate, and calcium carbonate.

The insulation composition of the present disclosure may additionally include an additive, for example, another inorganic filler, a stabilizer, an antioxidant, a plasticizer, and a lubricant.

2. Electric Wire

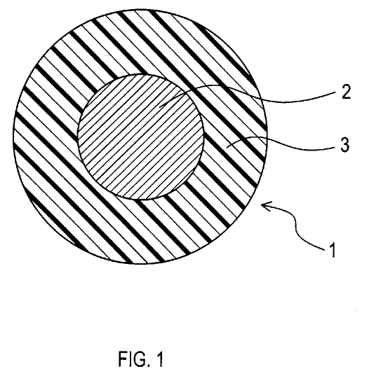

As shown, for example, in FIG. 1, an electric wire 1 of the present disclosure comprises a conductor 2 and a covering layer 3. The covering layer 3 covers the conductor 2. The covering layer 3 includes the insulation composition explained in the previous paragraphs of “1. Insulation composition”. The covering layer 3 may also include or need not include an extra component other than the insulation composition mentioned in the paragraphs of “1. Insulation composition”. As shown in FIG. 1, the covering layer 3 has a single-layer structure in the electric wire 1 of the present embodiment. The covering layer 3 may have a multi-layer structure comprising two or more layers.

3. Embodiments

(3-1) Production of Insulation Composition

Components listed in Table 1 are mixed and kneaded by a mixer to produce insulation compositions of embodiments 1 to 4, and comparative examples 1 to 6. In Table 1, the unit of blending amount for each component is parts by mass.

TABLE 1
(Unit of blending amount: parts by mass)

| | | | Embodiments | | | | Comparative Examples | | | | | |
|---|---|---|---|---|---|---|---|---|---|---|---|---|
| | | | 1 | 2 | 3 | 4 | 1 | 2 | 3 | 4 | 5 | 6 |
| Components | Component (a) | Tetrafluoroethylene- | 70 | 90 | 98 | 90 | 60 | 100 | 80 | 80 | 90 | 80 |
| | | propylene copolymer | | | | | | | | | | |
| | Component (b) | Ethylene-ethylacrylate | 30 | 10 | 2 | 10 | 40 | 0 | 20 | 20 | 10 | 20 |
| | | copolymer | | | | | | | | | | |
| | Cross-linking Agent | Organic peroxide | 2 | 2 | 2 | 2 | 2 | 2 | 2 | 2 | 2 | 2 |
| | Cross-linking | Allylic compound | 5 | 5 | 5 | 5 | 5 | 5 | 5 | 5 | 5 | 5 |
| | Assisting Agent | | | | | | | | | | | |
| | Acid Acceptor | Magnesium oxide | 1 | 1 | 1 | 1 | 1 | 1 | 1 | 1 | 1 | 1 |
| | Filler | Silica | 10 | 10 | 10 | 10 | 10 | 10 | 10 | 10 | 10 | 10 |
| | | Calcium carbonate | 10 | 10 | 10 | 10 | 10 | 10 | 10 | 10 | 10 | 10 |
| | Flame Retardant | Zinc tin oxide | 10 | 10 | 10 | 5 | 10 | 10 | 0 | 25 | 10 | 10 |
| | | Ethylenebis | 10 | 10 | 10 | 5 | 10 | 10 | 10 | 10 | 0 | 20 |
| | | (pentabromobenzene) | | | | | | | | | | |
| Evaluation | Tensile property | Tensile strength (MPa) | 11.8 | 13.1 | 15.1 | 13.5 | 9.4 | 15.5 | 11.3 | 10.5 | 12.1 | 11.1 |
| | | Stretch (%) | 260 | 340 | 370 | 360 | 190 | 380 | 230 | 200 | 290 | 210 |
| | Thermostability | Retention of Tensile | 86 | 102 | 108 | 105 | 76 | 110 | 95 | 71 | 100 | 77 |
| | | strength Aᵣ (%) | | | | | | | | | | |
| | | Retention of Stretch Bᵣ | 89 | 111 | 115 | 113 | 79 | 108 | 94 | 72 | 97 | 78 |
| | | (%) | | | | | | | | | | |
| | Flame retardance | Vertical burn test | Y | Y | Y | Y | N | Y | N | Y | N | Y |
| | | (VW-1) | | | | | | | | | | |

| | | | | | | | | | | |
|---|---|---|---|---|---|---|---|---|---|---|
| Price of Compound | L | L | L | L | L | H | L | L | L | L |
| (High: H, Low: L) | | | | | | | | | | |

“Tetrafluoroethylene-propylene copolymer” in Table 1 is AFLAS 150E, a product of AGC Inc. (formerly, Asahi Glass Co., Ltd).

“Ethylene-ethylacrylate copolymer” in Table 1 is NUC-6170, a product of NUC Corporation.

“Organic peroxide” in Table 1 is PERBUTIYL® P, a product of NOF Corporation (formerly, Nippon Oil and Fats Company, Limited. The composition included in PERBUTIYL® P is α,α′-Di (tert-butyl peroxide) diisopropylbenzene.

“Allylic compound” in Table 1 is TAIC™, a product of Nippon Kasei Chemical Company Limited (currently merged with Mitsubishi Chemical Corporation). The composition included in TAIC™ is triallyl isocyanurate.

“Magnesium oxide” in Table 1 is KYOWAMAG® 30, a product of Kyowa Chemical Industry Co., Ltd.

“Silica” in Table 1 is AEROSIL® R972, a product of Nippon Aerosil Co., Ltd.

“Calcium carbonate” in Table 1 is Softon 1200, a product of Shiraishi Kogyo Kaisha, Ltd.

“Zinc tin oxide” in Table 1 is Alcanex ZS, a product of Mizusawa Industrial Chemicals, Ltd.

“Ethylenebis (pentabromobenzene)” in Table 1 is SAYTEX8010, a product of Albemarle Japan Corporation.

(3-2) Production of Electric Wire

The electric wires were produced from the insulation compositions of the embodiments 1 to 4 and the comparative examples 1 to 6. The method of production is as explained below.

Each insulation composition was extruded by a 40 mm extruder to form a covering layer on a tin-plated copper twisted-wire-conductor that has an outer diameter of 0.9 mm. One covering layer includes only one insulation composition among the embodiments 1 to 4 and comparative examples 1 to 6. The temperature setting of the extruder is as mentioned below.

Cylinder 1: 80° C.

Cylinder 2: 80° C.

Cylinder 3: 80° C.

Head: 90° C.

Die: 100° C.

The covering layers were then cross-linked in steam under pressure at 13 atmosphere for three minutes to complete the production of the electric wires.

(3-3) Method of Evaluating Covering Layer

The tin-plated copper stranded wire conductors were taken out from the electric wires produced in the aforementioned (3-2). The remained tubular shaped covering layers were used as the samples. The samples are made from the insulation compositions. Each sample was evaluated in terms of the tensile property, the thermostability, and the flame retardance by the following methods. In addition, based on the compositions in the covering layer, the range of the price of compound of each insulation composition was determined.

(i) Tensile Property

The applied methods of evaluating the tensile property were compliant with JIS C 3005.

Measured properties were the tensile strength and the stretch. The results of measurements are shown in the above Table 1. If the sample has the tensile strength of 10 MPa or more and the stretch of 200% or more, the sample was given a pass in the tensile property.

(ii) Thermostability

The tensile strength and the stretch of each sample were measured in the same methods as the above item (i). The measured tensile strength was an initial tensile strength A₀. The measured stretch was an initial stretch B₀.

The sample was then placed in a heat-aging testing machine for four days. The temperature inside the heat-aging testing machine was 250° C. The sample was then removed from the heat-aging testing machine and measured for the tensile strength and the stretch using the same methods as the above item (i). The measured tensile strength here was a heat-aged tensile strength A₁. The measured stretch here was a heat-aged stretch B₁.

The following formula (1) was used to calculate the retention of a tensile strength Aᵣ (%).

Aᵣ=(A₁/A₀)×100 Formula (1)

The following formula (2) was used to calculate the retention of a stretch Bᵣ (%).

Bᵣ=(B₁/B₀)×100 Formula (2)

The calculated results of the retention of the tensile strength Aᵣ and the retention of the stretch Bᵣ are shown in the above Table 1. The sample was given a pass in the thermostability if the retention in tensile strength Aᵣ is 80% or more and the retention of the stretch Br is 80% or more.

(iii) Flame Retardance

The samples underwent a vertical combustion test (VW-1) compliant with UL758. The sample was given a pass if its self-extinguishing time was one minute or shorter. The sample was given a fail if its self-extinguishing time exceeded one minute. The results of the flame retardance evaluation are shown in the above Table 1. In Table 1, “Y” means a pass, and “N” means a fail.

(iv) Price of Compound

The price of compound of ethylene-ethylacrylate copolymer is notably low compared with the price of compound of copolymer of tetrafluoroethylene and alfa-olefin with the carbon number of 2 or more and 4 or less. Accordingly, the following estimates were made: if the mass proportion of ethylene-ethylacrylate copolymer in the resin component is 2 percent by mass or more, then the price of compound of the insulation composition is low; and if the mass proportion of ethylene-ethylacrylate copolymer in the resin component is less than 2 percent by mass, then the price of compound in the insulation composition is high. The results of the evaluation of the price of compound are shown in the above Table 1.

(3-4) Covering Layer Evaluation Results

As shown in the above Table 1, the insulation compositions of the embodiments 1 to 4 yielded favorable evaluation results in all of the tensile property, the thermostability, and the flame retardance. In addition, the price of compound of the insulation composition was low in the embodiments 1 to 4.

The insulation composition of the comparative example 1 was evaluated lower in terms of the tensile property, the thermostability, and the flame retardance. The reason for such a low evaluation is presumed that the mass proportion of ethylene-ethylacrylate copolymer in the resin component of the comparative example 1 was excessively high.

The insulation composition of the comparative example 2 has a high price of compound. The reason for this is presumed that the resin component was solely made from tetrafluoroethylene-propylene copolymer.

The insulation composition of the comparative example 3 was evaluated lower in terms of the flame retardance. The reason for this low evaluation is presumed that the content of the zinc tin oxide in the insulation composition was excessively low.

The insulation composition of the comparative example 4 was evaluated lower in terms of the thermostability. The reason for this low evaluation is presumed that the content of the zinc tin oxide in the insulation composition was excessively high.

The insulation composition of the comparative example 5 was evaluated lower in terms of the flame retardance. The reason for this low evaluation is presumed that the content of ethylenebis (pentabromobenzene) in the insulation composition was excessively low.

The insulation composition of the comparative example 6 was evaluated lower in terms of the thermostability. The reason for this low evaluation is that the content of ethylenebis (pentabromobenzene) in the insulation composition was excessively high.

4. Other Embodiments

The embodiments of the present disclosure have been explained above. Nevertheless, the present disclosure may be achieved in various modifications without being limited to the aforementioned embodiments.

(1) Functions of one element in the aforementioned embodiments may be achieved by two or more elements. Functions of two or more elements may be achieved by one element. A part of the configuration of the aforementioned embodiments may be omitted. At least a part of the configuration of the aforementioned embodiments may be added to or replaced with another configuration of the aforementioned embodiments. It should be noted that any and all modes that are encompassed in the technical ideas that are defined only by the languages in the claims are embodiments of the present disclosure.

(2) Other than the aforementioned insulation compositions and electric wires, the present disclosure may also be achieved in various other forms such as a method of producing an insulation composition, a method of producing an electric wire, and a system comprising an electric wire.

What is claimed is:

1. An insulation composition comprising:
100 parts by mass of a resin component,
2 parts by mass or more and 20 parts by mass or less of zinc tin oxide, and
0.3 parts by mass or more and 15 parts by mass or less of a bromine flame retardant,
the resin component comprising:
a first component including a copolymer of tetrafluoroethylene and alfa-olefin with the carbon number of 2 or more and 4 or less, and
a second component including ethylene-ethylacrylate copolymer,
mass proportion of the first component in the resin component being 70 percent by mass or more and 98 percent by mass or less, and
mass proportion of the second component in the resin component being 2 percent by mass or more and 30 percent by mass or less.

2. The insulation composition according to claim 1,
wherein the bromine flame retardant includes ethylenebis (pentabromobenzene).

3. The insulation composition according to claim 1,
wherein the first component includes tetrafluoroethylene-propylene copolymer.

4. The insulation composition according to claim 2,
wherein the first component includes tetrafluoroethylene-propylene copolymer.

5. An electric wire comprising:
a conductor, and
a covering layer configured to cover the conductor,
the covering layer comprising:
100 parts by mass of a resin component,
2 parts by mass or more and 20 parts by mass or less of zinc tin oxide, and
0.3 parts by mass or more and 15 parts by mass or less of a bromine flame retardant,
the resin component comprising:
a first component including a copolymer of tetrafluoroethylene and alfa-olefin with the carbon number of 2 or more and 4 or less, and
a second component including ethylene-ethylacrylate copolymer,
mass proportion of the first component in the resin component being 70 percent by mass or more and 98 percent by mass or less, and
mass proportion of the second component in the resin component being 2 percent by mass or more and 30 percent by mass or less.

6. The electric wire according to claim 5,
wherein the bromine flame retardant includes ethylenebis (pentabromobenzene).

7. The electric wire according to claim 5,
wherein the first component includes tetrafluoroethylene-propylene copolymer.

8. The electric wire according to claim 6,
wherein the first component includes tetrafluoroethylene-propylene copolymer.
